(19) United States
(12) Patent Application Publication
(10) Pub. No.: US 2021/0315203 A1
(43) Pub. Date: Oct. 14, 2021

(54) CRYSTALLIZATION INHIBITORS IN AGRICULTURAL FORMULATIONS

(71) Applicant: Vive Crop Protection Inc., Mississauga (CA)

(72) Inventors: Matthew Coulter, Toronto (CA); Hung Hoang Pham, Brampton (CA); Jordan Dinglasan, Mississauga (CA); Kirill Pastushenko, Mississauga (CA)

(21) Appl. No.: 17/271,358

(22) PCT Filed: Aug. 30, 2019
(86) PCT No.: PCT/IB2019/057356

§ 371 Date: Feb. 25, 2021

Related U.S. Application Data
(60) Provisional application No. 62/726,890, filed on Sep. 4, 2018.

(51) Int. Cl. A01N 25/04; A01N 25/30; A01N 47/40; A01N 37/22

(52) U.S. Cl. CPC A01N 25/04; A01N 37/22; A01N 47/40; A01N 25/30

(57) ABSTRACT

The present disclosure describes formulations and methods for agricultural production. The formulations comprise an active agricultural compound, a polymer, a dispersant and/or a wetting agent, and water, wherein the active is selected from the group consisting of fungicides, insecticides, nematicides, herbicides, safeners, growth regulators, and combinations thereof. The polymer is a polyelectrolyte comprising hydrophobic and hydrophilic monomers, such as, styrene, methacrylic acid, 2-acrylamido-2-methylpropane sulfonic acid and ethyl acrylate. The formulations described herein have reduced, inhibited and/or mitigated crystallization of the active compounds.

### CROSS-REFERENCE TO RELATED APPLICATION

This application claims priority to and the benefit of U.S. Provisional Patent Application No. 62/726,890, filed Sep. 4, 2018, the content of which is incorporated by reference herein in its entirety.

### BACKGROUND

The present invention relates to agricultural formulations in which at least one of the components is an active compound (e.g., an insecticide, fungicide, herbicide, among others) that is susceptible to crystal formation, or recrystallization in the particular media of the agricultural formulation (e.g., water). In the context of agricultural formulations, it is often important, especially for liquid-based formulations, to prevent crystal formation of the active compound. Crystal formation can lead to reduced storage stability, inconsistent application to the crop or field, disruption of application equipment (e.g., clogging), and in some cases, reduced efficacy. Processes to reduce crystal size (e.g., grinding, milling, etc.,) are expensive, and often impractical once an agricultural formulation is formulated and/or packaged. Thus there is a need to reduce, prevent, or mitigate crystal formation or recrystallization of active compounds in agricultural formulations.

### SUMMARY OF THE INVENTION

In various embodiments, the present invention includes a method of inhibiting crystallization of an active compound including preparing a formulation of the active compound by milling the active compound with a polymer, a dispersant and/or a wetting agent, and water. In some embodiments, the method includes an active compound selected from the group consisting of fungicides, insecticides, nematicides, herbicides, safeners, growth regulators, and combinations thereof.

In some embodiments, the method includes an active compound that has a water solubility of at least about 0.5 ppm at a temperature of about 25 degrees Celsius and a pH of about 7. In some embodiments, the method includes an active compound that has a water solubility of at least about 100 ppm at a temperature of about 25 degrees Celsius and a pH of about 7. In some embodiments, the method includes an active compound that has a water solubility of at least about 500 ppm at a temperature of about 25 degrees Celsius and a pH of about 7. In some embodiments, the method includes an active compound that has a water solubility of at least about 1000 ppm at a temperature of about 25 degrees Celsius and a pH of about 7. In some embodiments, the method includes an active compound that has a water solubility of less than about 10000 ppm at a temperature of about 25 degrees Celsius and a pH of about 7.

In some embodiments, the polymer is a polyelectrolyte.

In some embodiments, the polymer comprises hydrophobic and hydrophilic monomers.

In some embodiments, the polymer consists essentially of hydrophobic and hydrophilic monomers. In some embodiments, the polymer comprises styrene and methacrylic acid monomers. In some embodiments, the polymer has a weight ratio of styrene monomers to methacrylic acid monomers of between about 1:1: and about 1:9. In some embodiments, the polymer has a weight ratio of styrene monomers to methacrylic acid monomers of between about 2:3 and about 1:4. In some embodiments, the polymer has a weight ratio of styrene monomers to methacrylic acid monomers of about 3:7.

In some embodiments, the polymer comprises 2-Acrylamido-2-methylpropane sulfonic acid (AMPS) monomers and ethyl acrylate monomers. In some embodiments, the polymer has a weight ratio of AMPS monomers to ethyl acrylate monomers of between about 1:4 and about 4:1.

In some embodiments, the active compound is selected from the group consisting of acetamiprid, cloquintocet-mexyl, propanil, and metalaxyl. In some embodiments, the active compound is selected from neonicotinoid insecticides, phenylamide fungicides, anilide herbicides, amide herbicides, and herbicide safeners.

In various aspects the present inventions include a formulation including an active compound, a polymer, a dispersant, and/or a wetting agent, and water. In some embodiments, the active compound is selected from the group consisting of fungicides, insecticides, nematicides, herbicides, safeners, growth regulators, and combinations thereof.

In some embodiments, the active compound has a water solubility of at least about 0.5 ppm at a temperature of about 25 degrees Celsius and a pH of about 7. In some embodiments, the active compound has a water solubility of at least about 100 ppm at a temperature of about 25 degrees Celsius and a pH of about 7. In some embodiments, the active compound has a water solubility of at least about 500 ppm at a temperature of about 25 degrees Celsius and a pH of about 7. In some embodiments, the active compound has a water solubility of at least about 1000 ppm at a temperature of about 25 degrees Celsius and a pH of about 7. In some embodiments, the active compound has a water solubility of less than about 10000 ppm at a temperature of about 25 degrees Celsius and a pH of about 7. In some embodiments, the polymer comprises hydrophobic and hydrophilic monomers.

In some embodiments, the polymer consists essentially of hydrophobic and hydrophilic monomers. In some embodiments, the polymer comprises styrene and methacrylic acid monomers. In some embodiments, the polymer has a weight ratio of styrene monomers to methacrylic acid monomers of between about 1:1: and about 1:9. In some embodiments, the polymer has a weight ratio of styrene monomers to methacrylic acid monomers of between about 2:3 and about 1:4. In some embodiments, the polymer has a weight ratio of styrene monomers to methacrylic acid monomers of about 3:7.

In some embodiments, the polymer comprises AMPS monomers and ethyl acrylate monomers. In some embodiments, the polymer has a weight ratio of AMPS monomers to ethyl acrylate monomers of between about 1:4 and about 4:1.

### DESCRIPTION OF THE FIGURES

FIG. 1 is a series of photographs from microscope (400× magnification), of three different formulations of acetamiprid prepared according to Example 1. The formulation on the right was prepared without any crystallization inhibiting polymer, the formulation in the middle photo included a methacrylic acid-co-styrene polymer, and the formulation on the left picture included an AMPS-co-ethyl acrylate polymer.

FIG. 2 is a series of two photographs from microscope (400× magnification) of a formulation of acetamiprid containing crystallization inhibiting polymer prepared according to Example 2, both at the time of preparation (left side photograph) and after storage for two weeks at 54 degrees Celsius (right side photograph).

FIG. 3 is a photograph of two formulations of propanil herbicide, prepared according to Example 3.

FIG. 4 is a pair of photographs under microscope (400× magnification) of metalaxyl formulation prepared according to Example 4. The formulation in the photograph on the left includes polymeric crystallization inhibitor, and the formulation on the right omitted the polymer crystallization inhibitor.

FIG. 5 is a pair of photographs demonstrating the flowability of the two formulations prepared according to Example 4, by placing a sample of the formulation in a high-density polyethylene (HDPE) bottle and inverting the bottle. The formulation in the photograph on the left includes polymeric crystallization inhibitor, and the formulation on the right omitted the polymer crystallization inhibitor.

FIG. 6 is a pair of photographs from microscope (400× magnification) of a formulation of metalaxyl formulation prepared according to Example 6. The left side photograph is after the formulation was prepared, and the right photograph was after 3 weeks of storage at 45 degrees Celsius.

FIG. 7 is a photograph of various metalaxyl solutions prepared according to Example 7, after overnight storage at 54 degrees Celsius followed by 1 day storage at room temperature.

### DESCRIPTION OF VARIOUS EMBODIMENTS OF THE INVENTION

### Overview

The present invention relates to the use of polymers and other adjuvants used in conjunction with active compounds to prevent, reduce or mitigate crystallization or recrystallization of the active compounds. In some embodiments, the active compounds have certain physical and chemical properties that demonstrate a greater susceptibility, as compared to other active compounds in the same or similar class, to crystallization and recrystallization in a liquid environment, in particular, an aqueous environment. In some embodiments, the active compounds are moderately soluble in a liquid media. In some embodiments, the active compounds are moderately water soluble.

Applicant has recognized that specific polymers, alone or in combination, with specific compositions can limit, mitigate, or reduce the rate of crystal formation or growth in active compounds. In some embodiments, the polymers are used alone, or in combination, as part of an end-use, agricultural formulation. In some embodiments, the polymers are used in combination with certain surfactant compounds.

Crystal formation is also influenced by the storage conditions, in particular, temperature, as the rate of formation is, in part, dependent upon an active compound's water solubility, which is in turn variable based on temperature. In the current disclosure, controlled storage conditions are used in order to evaluate the crystal formation rate. In particular, storage at room temperature (e.g., approximately 22 degrees Celsius, or approximately 23 degrees Celsius), storage in temperature controlled oven at either 45 degrees Celsius or 54 degrees Celsius are used to evaluate crystal formation rate over fixed periods of time (e.g., approximately 1 week, approximately 2 weeks, approximately 3 weeks, approximately 6 weeks, approximately 1 month, approximately 2 months, approximately 3 months, approximately 4 months, approximately 6 months, approximately one year, approximately two years, etc.). These conditions and time periods are meant to recreate actual storage conditions and time periods for end-use agricultural formulation (e.g., approximately six-month storage at approximately room temperature) or to mimic long term storage in a shorter period of time by using a high temperature (e.g., approximately two weeks storage at approximately 54 degrees Celsius), or meant to recreate the temperature extremes encountered in the transport or storage of end-use agriculture formulations (e.g., approximately one week, or approximately two weeks at 45 degrees Celsius.).

By limiting, mitigating, or reducing the rate of crystal formation or growth in active compounds it meant that under certain conditions, the addition of the crystal inhibit polymer compounds to the end-use formulation, results in either smaller crystals formed (measured by e.g., average diameter, or average longest dimension), and/or fewer crystals in a given volume of the end-use formulation, as compared to an end-use formulation of the same composition, excepting the addition of the crystal inhibiting polymers.

A common storage stability test is to store end-use formulation samples for between about 3 weeks and about 6 weeks in an oven set at 45° C. This storage stability test is typical for end-use formulations in the agricultural formulation field. The samples can range in size from about 10 milliliters to about 1 liter.

In some embodiments, under these storage conditions (6 weeks of storage at 45° C.), the size of crystals formed of an end-use suspension concentrate formulation containing crystal inhibiting polymers, is reduced by approximately 10% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 15% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 20% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 25% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 30% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 40% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 50% as compared to an end-use suspension concentrate formulation of the same composition, excepting the addition of the crystal inhibiting polymers. In some embodiments, under these storage conditions (6 weeks of storage at 45° C.), the size of crystals formed of an end-use suspension concentrate formulation containing crystal inhibiting polymers, is reduced by approximately 60% as compared to an end-use suspension concentrate formulation of the same composition, excepting the addition of the crystal inhibiting polymers.

Another common storage stability test is to store end-use formulation samples for 2 weeks in an oven set to 54° C. This particular test is designed to approximate the results of storing the same samples for 2 years at room temperature. This storage stability test is typical for end-use formulations in the agricultural formulation field. The samples can range in size from 10 milliliters to 1 liter.

In some embodiments, under these storage conditions (2 weeks of storage at 54° C.), the size of crystals formed of an end-use suspension concentrate formulation containing crystal inhibiting polymers, is reduced by approximately 10% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 15% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 20% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 25% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 30% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 40% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 50% as compared to an end-use suspension concentrate formulation of the same composition, excepting the addition of the crystal inhibiting polymers. In some embodiments, under these storage conditions (2 weeks of storage at 54° C.), the size of crystals formed of an end-use suspension concentrate formulation containing crystal inhibiting polymers, is reduced by approximately 60% as compared to an end-use suspension concentrate formulation of the same composition, excepting the addition of the crystal inhibiting polymers.

### Polymers

In some embodiments, the polymer is a polyelectrolyte. Polyelectrolytes are polymers that contain monomer units of ionized or ionizable functional groups, they can be linear, branched, hyperbranched or dendrimeric, and they can be synthetic or naturally occurring. Ionizable functional groups are functional groups that can be rendered charged by adjusting solution conditions, while ionized functional group refers to chemical functional groups that are charged regardless of solution conditions. The ionized or ionizable functional group can be cationic or anionic, and can be continuous along the entire polymer chain (e.g., in a homopolymer), or can have different functional groups dispersed along the polymer chain, as in the case of a co-polymer (e.g., a random co-polymer). In some embodiments, the polymer can be made up of monomer units that contain functional groups that are either anionic, cationic, both anionic and cationic, and can also include other monomer units that impart a specific desirable property to the polymer.

In some embodiments, the polyelectrolyte is a homopolymer. Non limiting examples of homopolymer polyelectrolytes are: poly(acrylic acid), poly(methacrylic acid), poly(styrene sulfonate), poly(ethyleneimine), chitosan, poly(dimethylammonium chloride), poly(allylamine hydrochloride), and carboxymethyl cellulose.

In some embodiments, the polyelectrolyte is a co-polymer. In some embodiments, 2, 3, 4, or more different monomeric species can comprise the co-polymer. Generally, the monomer can be selected from any of the monomeric species described below, particularly including carboxylic acids, styrene, styrene based monomers, other aryl-vinyl monomers, alkyl acrylates, and other alpha-beta unsaturated monomers. In some embodiments, the co-polymer comprises at least one hydrophilic monomer species and at least one hydrophobic monomer species. In some embodiments, the polyelectrolyte co-polymer is poly(methacrylic acid-co-styrene).

In some embodiments, the polyelectrolyte can be made from one or more monomer units to form homopolymers, copolymers or graft copolymers of: carboxylic acids including acrylic acid, methacrylic acid, itaconic acid, and maleic acid; polyoxyethylenes or polyethylene oxide; and unsaturated ethylenic mono or dicarboxylic acids; lactic acids; amino acids; amines including dimethylammonium chloride, allylamine hydrochloride; along with other monomers such including methacrylic acid; ethyleneimine; ethylene; ethylene glycol; alkyl acrylates including methyl acrylate, ethyl acrylate, propyl acrylate, n-butyl acrylate (“BA”), isobutyl acrylate, 2-ethyl acrylate, and t-butyl acrylate; methacrylates including ethyl methacrylate, n-butyl methacrylate, and isobutyl methacrylate; acrylonitriles; methacrylonitrile; vinyls including vinyl acetate and partially hydrolyzed poly(vinyl acetate), vinylversatate, vinyl propionate, vinyl formamide, vinyl acetamide, vinyl pyridines, and vinyl limidazole; vinyl napthalene, vinyl naphthalene sulfonate, vinylpyrrolidone, vinyl alcohol; amino alkyls including amino alkylacrylates, amino alkylsmethacrylates, and aminoalkyl(meth)acrylamides; styrenes including styrene sulfonate, 2-Acrylamido-2-methylpropane sulfonic acid; d-glucosamine; glucaronic acid-N-acetylglucosamine; N-isopropylacrylamide; or vinyl amine. In some embodiments, the polyelectrolyte polymer can include groups derived from polysaccharides such as dextran, gums, cellulose, or carboxymethyl cellulose.

In some embodiments presenting co-polymers with two species of monomers the weight ratio of the monomer species (e.g., methacrylic acid to styrene in the poly(methacrylic acid co-styrene)) polymer is between about 50:50 and about 95:5. It is to be understood that any of the previously described monomers can be used in any of the ratio described herein. In some embodiments, the weight ratio of methacrylic acid to styrene in the poly(methacrylic acid co-styrene) polymer is between about 70:30 and about 95:5. In some embodiments, the weight ratio of methacrylic acid to styrene in the poly(methacrylic acid co-styrene) polymer is between about 80:20 and about 95:5. In some embodiments, the weight ratio of methacrylic acid to styrene in the poly(methacrylic acid co-styrene) polymer is between about 85:15 and about 95:5.

Additionally, a third, fourth, or fifth monomer species may be present in any amount up to about 40 percent by weight of the monomers in the polyelectrolyte polymer.

In some embodiments, the polyelectrolyte polymer has a weight average molecular weight between about 10,000 and about 4,000,000 Daltons. In some embodiments, the polyelectrolyte polymer has a weight average molecular weight of between about 10,000 and about 20,000 Daltons. In some embodiments, the polyelectrolyte polymer has a weight average molecular weight of between about 10,000 and about 50,000 Daltons. In some embodiments, the polyelectrolyte polymer has a weight average molecular weight of between about 10,000 and about 75,000 Daltons. In some embodiments, the polyelectrolyte polymer has a weight average molecular weight of between about 10,000 and about 100,000 Daltons. In some embodiments, the polyelectrolyte polymer has a weight average molecular weight of between about 10,000 and about 150,000 Daltons. In some embodiments, the polyelectrolyte polymer has a weight average molecular weight of between about 10,000 and about 200,000 Daltons.

In some embodiments, the polyelectrolyte polymer has a weight average molecular weight of between about 20,000 and about 50,000 Daltons. In some embodiments, the polyelectrolyte polymer has a weight average molecular weight of between about 20,000 and about 75,000 Daltons. In some embodiments, the polyelectrolyte polymer has a weight average molecular weight of between about 20,000 and about 100,000 Daltons. In some embodiments, the polyelectrolyte polymer has a weight average molecular weight of between about 20,000 and about 150,000 Daltons. In some embodiments, the polyelectrolyte polymer has a weight average molecular weight of between about 20,000 and about 200,000 Daltons. In some embodiments, the polyelectrolyte polymer has a weight average molecular weight of between about 50,000 and about 100,000 Daltons. In some embodiments, the polyelectrolyte polymer has a weight average molecular weight of between about 50,000 and about 150,000 Daltons. In some embodiments, the polyelectrolyte polymer has a weight average molecular weight of between about 20,000 and about 200,000 Daltons.

In some embodiments, the polyelectrolyte polymer has a weight average molecular weight of between about 100,000 and about 2,000,000 Daltons. In some embodiments, the polyelectrolyte polymer has a weight average molecular weight of between about 100,000 and about 1,000,000 Daltons. In some embodiments, the polyelectrolyte polymer has a weight average molecular weight of between about 100,000 and about 750,000 Daltons. In some embodiments, the polyelectrolyte polymer has a weight average molecular weight of between about 100,000 and about 500,000 Daltons. In some embodiments, the polyelectrolyte polymer has a weight average molecular weight of between about 100,000 and about 200,000 Daltons. In some embodiments, the polyelectrolyte polymer has a weight average molecular weight of between about 200,000 and about 2,000,000 Daltons. In some embodiments, the polyelectrolyte polymer has a weight average molecular weight of between about 200,000 and about 1,000,000 Daltons. In some embodiments, the polyelectrolyte polymer has a weight average molecular weight of between about 200,000 and about 500,000 Daltons. In some embodiments, the polyelectrolyte polymer has a weight average molecular weight of between about 300,000 and about 2,000,000 Daltons. In some embodiments, the polyelectrolyte polymer has a weight average molecular weight of between about 300,000 and about 1,000,000 Daltons. In some embodiments, the polyelectrolyte polymer has a weight average molecular weight of between about 300,000 and about 500,000 Daltons.

In some embodiments, the apparent molecular weight of the polyelectrolyte polymer (e.g., the molecular weight determined via certain analytical measurements such as size exclusion chromatography including gel permeation chromatography or DLS) is lower than the actual molecular weight of a polymer due to crosslinking within the polymer. In some embodiments, a crosslinked polyelectrolyte polymer of the present disclosure might have a higher actual molecular weight than the experimentally determined apparent molecular weight. In some embodiments, a crosslinked polyelectrolyte polymer of the present disclosure might be a high molecular weight polymer despite having a low apparent molecular weight.

The final formulations can be prepared with a range of average diameters, e.g., between about 1 nm and about 2000 nm (about 2 μm). The size of the nanoparticles can be adjusted in part by varying the size and number of polymers that are included in the nanoparticles. In some embodiments, the average diameter ranges from about 1 nm to about 10 nm, from about 1 nm to about 20 nm, from about 1 nm to about 30 nm, from about 1 nm to about 50 nm, from about 10 nm to about 50 nm, from about 10 nm to about 100 nm, from about 20 nm to about 100 nm, from about 20 nm to about 100 nm, from about 50 nm to about 200 nm, from about 50 nm to about 250 nm, from about 50 nm to about 300 nm, from about 100 nm to about 250 nm, from about 100 nm to about 300 nm, from about 200 nm to about 300 nm, from about 200 nm to about 500 nm, from about 250 nm to about 500 nm, from about 300 nm to about 500 nm from about 250 nm to about 1000 nm, from about 500 nm to about 1000 nm, from about 250 nm to about 2000 nm, from about 500 nm to about 1000 nm, from about 1000 nm to about 2000 nm. These and other average diameters described herein are based on volume average particle sizes that were measured in solution by dynamic light scattering on a Malvern Zetasizer ZS in CIPAC D water, 0.1M NaCl, or in deionized water at 200 ppm active concentration. Various forms of microscopies can also be used to visualize the sizes of the nanoparticles such as atomic force microscopy (AFM), transmission electron microscopy (TEM), scanning electron microscopy (SEM) and optical microscopy.

### Association

In some embodiments, the active compound is associated with the polyelectrolyte polymer. In some embodiments, the associating step may involve milling the active compound in the presence of polyelectrolyte polymer. It is surprising that if the active compound alone is milled under these conditions, the resulting particle size is significantly larger than if it is milled in the presence of the polyelectrolyte polymer. In general, size reduction processes such as milling do not enable the production of particle sizes that are produced via milling in the presence of polyelectrolyte polymer of the current disclosure, without excessively long milling times. Without wishing to be bound by any theory, it is thought that interaction between the active compound and the polyelectrolyte polymer during the milling process facilitates the production of smaller particles than would be formed via milling in the absence of the polyelectrolyte polymer.

Non-limiting examples of milling methods that may be used for the association step can be found in U.S. Pat. No. 6,604,698 and include ball milling, bead milling, jet milling, media milling, and homogenization, as well as other milling methods known to those of skill in the art. Non-limiting examples of mills that can be for the association step include attritor mills, ball mills, colloid mills, high pressure homogenizers, horizontal mills, jet mills, swinging mills, and vibratory mills. In some embodiments, the associating step may involve milling the active compound in the presence of the pre-formed polymer nanoparticles and an aqueous phase. In some embodiments, the associating step may involve wet or dry milling of the active compound in the presence of the pre-formed polymer nanoparticles. In some embodiments, the association step may involve milling the active compound and pre-formed polymer nanoparticles in the presence of one or more formulating agents.

In general, the active compound may be associated with regions of the polymer that elicit a chemical or physical interaction with the active compound. Chemical interactions can include hydrophobic interactions, affinity pair interactions, H-bonding, and van der Waals forces. Physical interactions can include entanglement in polymer chains or inclusion within the polymer structure. The active compound can be associated in the interior of the pre-formed polymer nanoparticles, on the surface of the pre-formed polymer nanoparticles, or both the surface and the interior of the pre-formed polymer nanoparticles. Furthermore, the type of association interactions between the active compound and the polymer can be probed using spectroscopic techniques such as Nuclear Magnetic Resonance (NMR), Infra-Red (IR), Ultraviolet-Visible (UV-vis), and emission spectroscopies. For example, in cases where the active compound is normally crystalline when not associated with the polymer, the polymer-associated active compounds typically do not show the endothermic melting peak or show a reduced endothermic melting peak of the pure crystalline active compound as seen in differential thermal analysis (DTA) or differential scanning calorimetry (DSC) measurements. In general, applicant has discovered that depending on the nature of the polymer that active compounds that are hydrophobic, water-insoluble, and/or have relatively high melting point (e.g., greater than about 60 degrees C., or greater than about 70 degrees C.) are best suited for association with the polymers described in this disclosure.

The polymer-associated active compounds and/or aggregates of these can be part of a formulation in different amounts. The final amount will depend on many factors including the type of formulation. In some instances, the composition including both the polymer and active compound makes up between about 1 and about 98 weight % of the total formulation. In some embodiments, the polymer-active compound composition makes up between about 1 and about 90 weight % of the total formulation. In some embodiments, the polymer-active compound makes up between about 1 and about 75 weight % of the total formulation. In some embodiments, the polymer-active compound makes up between about 1 and about 50 weight % of the total formulation. In some embodiments, the polymer-active compound makes up between about 1 and about 30 weight % of the total formulation. In some embodiments, the polymer-active compound makes up between about 1 and about 25 weight % of the total formulation. In some embodiments, the polymer-active compound makes up between about 1 and about 10 weight % of the total formulation. In some embodiments, the polymer-active compound makes up between about 10 and about 25 weight % of the total formulation. In some embodiments, the polymer-active compound makes up between about 10 and about 30 weight % of the total formulation. In some embodiments, the polymer-active compound makes up between about 10 and about 50 weight % of the total formulation. In some embodiments, the polymer-active compound makes up between about 25 and about 50 weight % of the total formulation.

In some embodiments, the nanoparticles of polymer-associated active compounds are prepared according to a method disclosed in U.S. Patent Application Publication No. 20100210465, the entire contents of which are incorporated herein by reference. In some embodiments, polymer nanoparticles without active compounds are made by the collapse of a polyelectrolyte with a collapsing agent and then rendering the collapsed conformation permanent by intra-particle cross-linking. The active compound is then associated with this preformed polymer nanoparticle. In some embodiments, the formulation contains the same amount (by weight) of active compound and polymer, while in other embodiments the ratio of active compound to polymer (by weight) can be between about 1:10 and about 10:1, between about 1:10 and about 1:5, between about 1:5 and about 1:4, between about 1:4 and about 1:3, between about 1:3 and about 1:2, between about 1:2 and about 1:1, between about 1:5 and about 1:1, between about 5:1 and about 1:1, between about 2:1 and about 1:1, between about 3:1 and about 2:1, between about 4:1 and about 3:1, between about 5:1 and about 4:1, between about 10:1 and about 5:1, between about 1:3 and about 3:1, between about 5:1 and about 1:1, between about 1:5 and about 5:1, or between about 1:2 and about 2:1.

### Actives

Generally, any active compounds are applicable to the formulations of the present invention. Of interest are agriculturally active compounds, including insecticides, herbicides, and fungicides. Of additional interest are active compounds that are susceptible to crystallization, particularly crystallization in water. Active compounds that are susceptible to crystallization in water tend to be moderately soluble in water, in that they have a water solubility of at least about 0.01 ppm (mg/L) in water at about 20 degrees C., atmospheric pressure and neutral pH (e.g., about pH of about 7). An additional factor is the readiness of the active compound to form crystals in water, as some active compounds do not readily form crystal in water, regardless of water solubility. Another factor is the general shape of the crystals that form, with elongate shapes, or one dimension of the crystal significantly larger than the other two dimensions (e.g., very long, but narrow, and shallow crystal shape, e.g., needle or rod like crystals).

Without being bound to any theory, it is thought that the moderate water solubility of the active compound can lead to crystallization, because the active compound is repeatedly dissolving and precipitating from the solvent water, each transition leading to potential additional crystal growth. In conjunction with the active compound's tendency to form crystals, and possibly the elongate shape of the crystals, an active compound with moderate solubility may be very difficult to formulate in a water based formulation (e.g., a suspension concentrate) because of the crystal formation. Or the active compound formulation may not be stable for long storage periods (e.g., about 1 year, about 2 years) or at varying temperature (e.g., between about 0 and about 50 degrees Celsius) due to the susceptibility of crystal formation.

It is to be appreciated that all three properties of the active compound (e.g., water solubility, readiness to form crystals in water, and relative shape of crystals) all influence the overall susceptibility of the active compound to crystallize, and in particular crystallize in a way that impacts long term storage stability of the formulation. In some embodiments a compound that is relatively water insoluble, but readily forms crystals, may demonstrate poor storage stability. Or a compound with relatively high water solubility, for that form elongate crystals, may demonstrate poor storage stability.

Though any active compound can be formulated with according to the disclosure herein, preferred active compounds include those with a water solubility of greater than about 0.01 ppm, a water solubility of greater than about 0.05 ppm, a water solubility of greater than about 0.1 ppm, a water solubility of greater than about 0.5 ppm, a water solubility of greater than about 1 ppm, a water solubility of greater than about 10 ppm, a water solubility of greater than about 50 ppm, a water solubility of greater than about 100 ppm, a water solubility of greater than about 200 ppm, a water solubility of greater than about 500 ppm, a water solubility of greater than about 1000 ppm, a water solubility of greater than about 5000 ppm, or a water solubility of greater than about 10000 ppm. Generally active compounds with a water solubility of 50 g/L (50000 ppm) or higher do not benefit from formulation preparation, including polymers, as disclosed herein. It is to be appreciated that water solubility numbers are generally for a temperature of about 20 degrees C., atmospheric pressure and a pH of about 7.

Another feature of active compounds suitable for application to the disclosure formulations includes hydrophobic groups as a feature of the chemical structure of the active compound. Without being bound to a particular theory, it is considered that the polymer compounds of the instant disclosure, when formulated with the active compound, serve to interfere with the formation of crystals. In one regard, the polymer's hydrophobic portions interact with the generally hydrophobic active compounds to prevent the active compound for dissolving in the water of the formulation, thereby interrupting the solution-dissolution sequence described herein. It is also theorized that the polymer compounds insulate already formed crystals from either other active compound crystals or dissolved active compounds to prevent or slow crystal growth rates.

Generally, the formulations of active compounds to which the present disclosure is applicable include any formulation form that could lead to the formation of active compound crystals. The forms of formulation include solid formulations (wettable powder, water dispersible granule, dry granules) as well as liquid formulations. Generally the water based liquid formulations are most subject to reduced storage stability or other deficiencies due to crystal formation, and particular, water based formulations that use sparingly, or moderately water soluble active compounds, as described above. In particular the disclosed inventions are most applicable to suspension concentrate, oil dispersion, microencapsulation formulations, though it is possible to use the disclosed inventions in emulsifiable concentrate, microemulsion, and even soluble concentrate formulations. In certain formulation form, e.g., suspension concentrates, which do not require dissolution of the active compound, but instead rely on suspension, crystallization is a particularly pernicious problem. The formation of solids in a concentrated formulation can lead to settling of the active compound, inconsistent concentration of the active compound throughout the formulation (e.g., due to settling), clogging of machinery, due to increased particle size, and increased viscosity, among other problems, yielding an unstable formulation. These problems can be enhanced due to temperature fluctuations during storage which can increase crystal growth, as described above.

The disclosed inventions, in particular, use of crystal inhibiting polymer compounds (either as a polymer or in a nanoparticle form), by limiting, mitigating, or reducing the rate of crystal formation or growth can make an otherwise unstable formulation into a stable formulation. Use of the compounds disclosed herein can enable a manufacturer to produce a stable formulation, or a formulation with enhanced stability.

In some embodiments, active compounds are any of those described herein that are also moderately water soluble, and/or susceptible to crystallization, as described herein. Mixtures of active compounds from two or more of the abovementioned classes may also be used. The skilled worker is familiar with such active compounds, which can be found, for example, in Pesticide Manual, 17th Ed. (2015), The British Crop Protection Council, London.

Fungicides: Respiration Inhibitors: complex-III-inhibitors at the Qₒ-site (for example strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-m-ethoxyimino-N-methylacetamide, pyribencarb, triclopyricarb/chlorodincarb, famoxadon, fenamidon; complex-III-inhibitors at the Q-site: cyazofamid, amisulbrom; complex-II-inhibitors (for example carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthio-biphenyl-2-yl)-3-difluoromethyl-1-methyl-1H-pyr-azole-4-carboxamide, N-(2-(1,3,3-trimethylbutyl)phenyl)-1,3-dimethyl-5-fluoro-1H-pyrazole-4-ca-rboxamide and N-[9-(dichloromethylene)-1,2,3,4-tetrahydro-1,4-methanonaphthalen-5-yl]-3--(difluoromethyl)-1-methyl-1H-pyrazole-4-carboxamide.

Other respiration inhibitors (for example complex I, decouplers): diflumetorim; nitrophenyl derivatives: binapacryl, dinobuton, dinocap, fluazinam; ferimzone; organometal compounds: fentin salts such as fentin acetate, fentin chloride or fentine hydroxide; ametoctradin; and silthiofam.

Sterol Biosynthesis Inhibitors (SBI Fungicides): C14-demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizole; pyrimidines, pyridines and piperazines: fenarimol, nuarimol, pyrifenox, triforine; delta14-reductase inhibitors: aldimorph, dodemorph, dodemorph acetate, fenpropimorph, tridemorph, fenpropidin, piperalin, spiroxamine; 3-ketoreductase inhibitors: fenhexamid.

Nucleic Acid Synthesis Inhibitors: phenylamides or acylamino acid fungicides: benalaxyl, benalaxyl-m, kiralaxyl, metalaxyl, metalaxyl-M (mefenoxam), ofurace, oxadixyl; others: hymexazole, octhilinone, oxolinic acid, bupirimate.

Cell Division and Cytoskeleton Inhibitors: tubulin inhibitors such as benzimidazoles, thiophanates: benomyl, carbendazim, fuberidazole, thiabendazole, thiophanate-methyl; triazolopyrimidines: 5-chloro-7-(4-methyl-piperidin-1-yl)-6-(2,4,6-trifluorophenyl)-[1,2,4]tri-azolo[1,5-a]pyrimidine; further cell division inhibitors: diethofencarb, ethaboxam, pencycuron, fluopicolid, zoxamid, metrafenon, pyriofenon.

Amino Acid Synthesis and Protein Synthesis Inhibitors: methionine synthesis inhibitors (anilinopyrimidines): cyprodinil, mepanipyrim, pyrimethanil; protein synthesis inhibitors: blasticidin-S, kasugamycin, kasugamycin hydrochloride hydrate, mildiomycin, streptomycin, oxytetracyclin, polyoxin, validamycin A.

Signal Transduction Inhibitors: MAP/histidine kinase inhibitors: fluoroimide, iprodione, procymidone, vinclozolin, fenpiclonil, fludioxonil; G-protein inhibitors: quinoxyfen.

Lipid and Membrane Synthesis Inhibitors:phospholipid biosynthesis inhibitors: edifenphos, iprobenfos, pyrazophos, isoprothiolane; lipid peroxidation: dicloran, quintozene, tecnazene, tolclofos-methyl, biphenyl, chloroneb, etridiazole; phospholipid biosynthesis and cell wall attachment: dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate; compounds which affect cell membrane permeability and fatty acids: propamocarb, propamocarb hydrochloride.

“Multi-Site” Inhibitors: inorganic active substances: Bordeaux mixture, copper acetate, copper hydroxide, copper oxychloride, basic copper sulfate, sulfur; thio- and dithiocarbamates: ferbam, mancozeb, maneb, metam, metiram, propineb, thiram, zineb, ziram; organochlorine compounds (for example phthalimides, sulfamides, chloronitriles): anilazine, chlorothalonil, captafol, captan, folpet, dichlofluanid, dichlorophen, flusulfamide, hexachlorobenzene, pentachlorophenol and its salts, phthalid, tolylfluanid, N-(4-chloro-2-nitrophenyl)-N-ethyl-4-methylbenzenesulfonamide; guanidines and others: guanidine, dodine, dodine-free base, guazatin, guazatin acetate, iminoctadin, iminoctadin triacetate, iminoctadin tris(albesilate), dithianon.

Cell Wall Biosynthesis Inhibitors: glucan synthesis inhibitors: validamycin, polyoxin B; melanin synthesis inhibitors: pyroquilon, tricyclazole, carpropamid, dicyclomet, fenoxanil.

Resistance Inductors: : acibenzolar-5-methyl, probenazol, isotianil, tiadinil, prohexadione-calcium; phosphonates: fosetyl, fosetyl-aluminum, phosphorous acid and its salts.

Unknown Mode of Action: bronopol, quinomethionate, cyflufenamid, cymoxanil, dazomet, debacarb, diclomezin, difenzoquat, difenzoquat-methyl sulfate, diphenylamine, fenpyrazamine, flumetover, flusulfamid, flutianil, methasulfocarb, nitrapyrin, nitrothal-isopropyl, oxine-copper, proquinazid, tebufloquin, tecloftalam, triazoxide, 2-butoxy-6-iodo-3-propylchromene-4-one, N-(cyclopropylmethoxyimino-(6-difluoromethoxy-2,3-difluorophenyl)methyl)--2-phenyl-acetamide, N′-(4-(4-chloro-3-trifluoromethylphenoxy)-2,5-dimethylphenyl)-N-ethyl-N-m-ethylformamidine, N′-(4-(4-fluoro-3-trifluoromethylphenoxy)-2,5-dimethylphenyl)-N-ethyl-N-m-ethylformamidine, N′-(2-methyl-5-trifluoromethyl-4-(3-trimethylsilanylpropoxy)phenyl)-N-eth-yl-N-methylformamidine, N′-(5-difluoromethyl-2-methyl-4-(3-trimethylsilanylpropoxy)-phenyl)-N-eth-yl-N-methylformamidine, N-methyl-(1,2,3,4-tetrahydronaphthalen-1-yl)-2-{1-[2-(5-methyl-3-trifluor-omethylpyrazol-1-yl)acetyl]piperidin-4-yl}thiazole-4-carboxamide, N-methyl-(R)-1,2,3,4-tetrahydronaphthalen-1-yl 2-{1-[2-(5-methyl-3-trifluoromethylpyrazol-1-yl)-acetyl]piperidin-4-yl}th-iazole-4-carboxamide, 1-[4-[4-[5-(2,6-difluorophenyl)-4,5-dihydro-3-isoxazolyl]-2-thiazolyl]-1--piperidinyl]-2-[5-methyl-3-(trifluoromethyl)-1H-pyrazol-1-yl]ethanone, 6-tert.-butyl-8-fluoro-2,3-dimethylquinolin-4-yl methoxyacetate, N-methyl-2-{1-[(5-methyl-3-trifluoromethyl-1H-pyrazol-1-yl)acetyl]piperid-in-4-yl}-N-[(1R)-1,2,3,4-tetrahydronaphthalen-1-yl]-4-thiazolecarboxamide, 3-[5-(4-methylphenyl)-2,3-dimethylisoxazolidin-3-yl]-pyridine, 3-[5-(4-chlorophenyl)-2,3-dimethylisoxazolidin-3-yl]-pyridine(pyrisoxazol-), N-(6-methoxypyridin-3-yl)cyclopropanecarboxamide, 5-chloro-1-(4,6-dimethoxypyrimidin-2-yl)-2-methyl-1H-benzoimidazole, 2-(4-chlorophenyl)-N-[4-(3,4-di-methoxyphenyl)isoxazol-5-yl]-2-prop-2-yny-loxyacetamide.

Growth Regulators: abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole.

Herbicides: acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor; amino acid analogs: bilanafos, glyphosate, glufosinate, sulfosate; aryloxyphenoxypropionates: clodinafop, cyhalofop-butyl, fenoxaprop, fluazifop, haloxyfop, metamifop, propaquizafop, quizalofop, quizalofop-P-tefuryl; bipyridyls: diquat, paraquat; carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate; cyclohexanediones: butroxydim, clethodim, cycloxydim, profoxydim, sethoxydim, tepraloxydim, tralkoxydim; dinitroanilines: benfluralin, ethalfluralin, oryzalin, pendimethalin, prodiamine, trifluralin; diphenyl ethers: acifluorfen, aclonifen, bifenox, diclofop, ethoxyfen, fomesafen, lactofen, oxyfluorfen; hydroxybenzonitriles: bromoxynil, dichlobenil, ioxynil; imidazolinones: imazamethabenz, imazamox, imazapic, imazapyr, imazaquin, imazethapyr; phenoxyacetic acids: clomeprop, 2,4-dichlorophenoxyacetic acid (2,4-D), 2,4-DB, dichlorprop, MCPA, MCPA-thioethyl, MCPB, mecoprop; pyrazines: chloridazon, flufenpyr-ethyl, fluthiacet, norflurazon, pyridate; pyridines: aminopyralid, clopyralid, diflufenican, dithiopyr, fluridone, fluoroxypyr, picloram, picolinafen, thiazopyr; sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimeth-oxypyrimidin-2-yl)urea; triazines: ametryne, atrazine, cyanazine, dimethametryne, ethiozine, hexazinone, metamitron, metribuzine, prometryne, simazine, terbuthylazine, terbutryne, triaziflam; ureas: chlortoluron, daimuron, diuron, fluometuron, isoproturon, linuron, methabenzthiazuron, tebuthiuron.

Other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam.

Other herbicides: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxy-methyl)-6-trifluoromethylpyridin-3-carbon-yl]bicyclo[3.2.1]oct-3-en-2-one, ethyl (3-[2-chloro-4-fluoro-5-(3-methyl-2,6-dioxo-4-trifluoromethyl-3,6-dihydro--2H-pyrimidin-1-yl)phenoxy]pyridin-2-yloxy)acetate, methyl 6-amino-5-chloro-2-cyclopropylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxy-phenyl)pyridin-2-carboxylate and methyl 4-amino-3-chloro-6-(4-chloro-3-dimethylamino-2-fluorophenyl)pyridin-2-carboxylate.

Insecticides: organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;

Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin.

Insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate.

Nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane; GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thi-ocarboxamide; macrocyclic lactones: abamectin, emamectin, milbemectin, lepimectin, spinosad, spinetoram; mitochondrial electron transport chain inhibitor (METI) I acaricides: fenazaquin, pyridaben, tebufenpyrad, tolfenpyrad, flufenerim; METI II and III substances: acequinocyl, fluacyprim, hydramethylnone; decouplers: chlorfenapyr; inhibitors of oxidative phosphorylation: cyhexatin, diafenthiuron, fenbutatin oxide, propargite; insect ecdysis inhibitors: cryomazine; mixed function oxidase inhibitors: piperonyl butoxide.

sodium channel blockers: indoxacarb, metaflumizone; [0087] others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluoron and pyrifluquinazone. Others: broflanilide, tioxazafen.

Safeners: benoxacor, BPCMS (4-bromophenyl chloromethyl sulfone), cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, metcamifen, naphthalic anhydride, oxabetrinil.

### Adjuvants

Co-formulation ingredients include those products or ingredients that contain inorganic cations and may be selected from one or more of adjuvants, antifoam agents, antimicrobial agents, buffering agents, corrosion inhibitors, defoaming agents, deposition agents, dispersants, drift control agents, dyes, freezing point depressants, neutralizing agents, penetration aids, sequestering agents, spreading agents, stabilizers, sticking agents, suspension aids, viscosity-modifying additives, wetting agents and the like.

In some embodiments, a formulation may include a dispersant or wetting agent or both. In some embodiments, the same compound may act as both a dispersant and a wetting agent. A dispersant is a compound that helps the nanoparticles (or aggregates of nanoparticles) disperse in water. Without wishing to be bound by any theory, dispersants are thought to achieve this result by absorbing on to the surface of the nanoparticles and thereby limiting re-aggregation. Wetting agents increase the spreading or penetration power of a liquid when placed onto the substrate (e.g., leaf). Without wishing to be bound by any theory, wetting agents are thought to achieve this result by reducing the interfacial tension between the liquid and the substrate surface.

In a similar manner, some formulating agents may demonstrate multiple functionalities. The categories and listings of specific agents below are not mutually exclusive. For example, fumed silica, described below in the thickener/anti-settling agent and anti-caking agent sections, is typically used for these functions. In some embodiments, however, fumed or hydrophilic silica demonstrates the functionality of a wetting agent and/or dispersant. Specific formulating agents listed below are categorized based on their primary functionality. However, it is to be understood that particular formulating agents may exhibit multiple functions. Certain formulation ingredients display multiple functionalities and synergies with other formulating agents and may demonstrate superior properties in a particular formulation but not in another formulation.

In some embodiments, a dispersant or wetting agent is selected from organosilicones (e.g., Sylgard 309 from Dow Corning Corporation or Silwet L77 from Union Carbide Corporation) including polyalkylene oxide modified polydimethylsiloxane (Silwet L7607 from Union Carbide Corporation), methylated seed oil, and ethylated seed oil (e.g., Scoil from Agsco or Hasten from Wilfarm), alkylpolyoxyethylene ethers (e.g., Activator 90), alkylarylalolates (e.g., APSA 20), alkylphenol ethoxylate and alcohol alkoxylate surfactants (e.g., products sold by Huntsman), fatty acid, fatty ester and fatty amine ethoxylates (e.g., products sold by Huntsman), products sold by Cognis such as sorbitan and ethoxylated sorbitan esters, ethoxylated vegetable oils, alkyl, glycol and glycerol esters and glycol ethers, tristyrylphenol ethoxylates, anionic surfactants such as sulfonates and sulfosuccinates, alkylaryl sulphonates, alkyl naphthalene sulfonates (e.g., products sold by Adjuvants Unlimited), calcium alkyl benzene sulphonates, phosphate esters (e.g., products sold by Huntsman Chemical or BASF), as salts of sodium, potassium, ammonium, magnesium, triethanolamine (TEA), etc.

Other specific examples of the above sulfates include ammonium lauryl sulfate, magnesium lauryl sulfate, sodium 2-ethyl-hexyl sulfate, sodium actyl sulfate, sodium oleyl sulfate, sodium tridecyl sulfate, triethanolamine lauryl sulfate, ammonium linear alcohol, ether sulfate ammonium nonylphenol ether sulfate, and ammonium monoxynol-4-sulfate. Other examples of dispersants and wetting agents include, sulfo succinamates, disodium N-octadecylsulfo-succinamate; tetrasodium N-(1,2-dicarboxyethyl)-N-octadecylsulfo-succinamate; diamyl ester of sodium sulfosuccinic acid; dihexyl ester of sodium sulfosuccinic acid; and dioctyl esters of sodium sulfosuccinic acid; dihexyl ester of sodium sulfosuccinic acid; and dioctyl esters of sodium sulfosuccinic acid; castor oil and fatty amine ethoxylates, including sodium, potassium, magnesium or ammonium salts thereof. Dispersants and wetting agents also include natural emulsifiers, such as lecithin, fatty acids (including sodium, potassium or ammonium salts thereof) and ethanolamides and glycerides of fatty acids, such as coconut diethanolamide and coconut mono- and diglycerides. Dispersants and wetting agents also include sodium polycarboxylate (commercially available as Geropon TA/72); sodium salt of naphthalene sulfonate condensate (commercially available as Morwet (D425, D809, D390, EFW); calcium naphthalene sulfonates (commercially available as DAXAD 19LCAD); sodium lignosulfonates and modified sodium lignosulfonates; aliphatic alcohol ethoxylates; ethoxylated tridecyl alcohols (commercially available as Rhodasurf (BC420, BC610, BC720, BC 840); Ethoxylated tristeryl phenols (commercially available as Soprophor BSU); sodium methyl oleyl taurate (commercially available as Geropon T-77); tristyrylphenol ethoxylates and esters; ethylene oxide-propylene oxide block copolymers; non-ionic copolymers (e.g., commercially available Atlox 4913); and non-ionic block copolymers (commercially available as Atlox 4912). Examples of dispersants and wetting agents include, but are not limited to, sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; aliphatic alcohol ethoxylates; and nonylphenol ethoxylates. Dispersants and wetting agents also include sodium taurates; sodium or ammonium salts of maleic anhydride copolymers, and lignosulfonic acid formulations; condensed sulfonate sodium, potassium, magnesium or ammonium salts; polyvinylpyrrolidone (available commercially as Polyplasdone XL-10 from International Specialty Products or as Kollidon Cl M-10 from BASF Corporation); polyvinyl alcohols; modified or unmodified starches, methylcellulose, hydroxyethyl or hydroxypropyl methylcellulose, and carboxymethyl methylcellulose; and combinations, such as a mixture of either lignosulfonic acid formulations or condensed sulfonate sodium, potassium, magnesium or ammonium salts with polyvinylpyrrolidone (PVP).

In some embodiments, the dispersants and wetting agents can combine to make up between about 0.5 and about 30 weight % of the formulation. For example, dispersants and wetting agents can make up between about 0.5 and about 20 weight %, about 0.5 and about 10 weight %, between about 0.5 and about 5 weight %, between about 0.5 and about 3 weight %, between about 1 and about 30 weight %, between about 1 and about 20 weight %, between about 1 and about 10 weight %, between about 1 and about 5 weight %, between about 2 and about 30 weight %, between about 2 and about 20 weight %, between about 2 and about 10 weight %, between about 2 and about 5 weight %, between about 3 and about 30 weight %, between about 3 and about 20 weight %, between about 3 and about 10 weight %, between about 3 and about 5 weight %, between about 5 and about 30 weight %, between about 5 and about 20 weight %, or between about 5 and about 10 weight % of the formulation. In some embodiments, dispersants or wetting agents can make up between about 0.1 and 1 weight % of the formulation, between about 0.1 and 2 weight % of the formulation between about 0.1 and 3 weight % of the formulation between about 0.1 and 5 weight % of the formulation, or between about 0.1 and 10 weight % of the formulation.

In some embodiments, a formulation may include an inert filler. For example, an inert filler may be included to produce or promote cohesion in forming a wettable granule formulation. An inert filler may also be included to give the formulation certain active loading, density, or other similar physical properties. Non limiting examples of inert fillers that may be used in a formulation include bentonite clay, carbohydrates, proteins, lipids synthetic polymers, glycolipids, glycoproteins, lipoproteins, lignin, lignin derivatives, and combinations thereof. In a preferred embodiment, the inert filler is a lignin derivative and is optionally calcium lignosulfonate. In some embodiments, the inert filler is selected from the group consisting of: monosaccharides, disaccharides, oligosaccharides, polysaccharides and combinations thereof. Specific carbohydrate inert fillers illustratively include glucose, mannose, fructose, galactose, sucrose, lactose, maltose, xylose, arabinose, trehalose and mixtures thereof such as corn syrup; sugar alcohols including: sorbitol, xylitol, ribitol, mannitol, galactitol, fucitol, iditol, inositol, volemitol, isomalt, maltitol, lactitol, polyglycitol; celluloses such as carboxymethylcellulose, ethylcellulose, hydroxyethylcellulose, hydroxy-methylethylcellulose, hydroxyethylpropylcellulose, methylhydroxyethylcellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; vegetable oils such as corn, soybean, peanut, canola, olive and cotton seed; complex organic substances such as lignin and nitrolignin; derivatives of lignin such as lignosulfonate salts illustratively including calcium lignosulfonate and sodium lignosulfonate; and complex carbohydrate-based formulations containing organic and inorganic ingredients such as molasses. Suitable protein inert fillers illustratively include soy extract, zein, protamine, collagen, and casein. Inert fillers operative herein also include synthetic organic polymers capable of promoting or producing cohesion of particle components and such inert fillers illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex.

In some embodiments, a formulation contains between about 1 and about 90 weight % inert filler, between about 1 and about 80 weight %, between about 1 and about 60 weight %, between about 1 and about 40 weight %, between about 1 and about 25 weight %, between about 1 and about 10 weight %, between about 10 and about 90 weight %, between about 10 and about 80 weight %, between about 10 and about 60 weight %, between about 10 and about 40 weight %, between about 10 and about 25 weight %, between about 25 and about 90 weight %, between about 25 and about 80 weight %, between about 25 and about 60 weight %, between about 25 and about 40 weight %, between about 40 and about 90 weight %, between about 40 and about 80 weight %, or between about 60 and about 90 weight %.

In some embodiments, a formulation may include a solvent or a mixture of solvents that can be used to assist in controlling the solubility of the active ingredient itself, the nanoparticles of polymer-associated active ingredients, or other components of the formulation. For example, the solvent can be chosen from water, alcohols, alkenes, alkanes, alkynes, phenols, hydrocarbons, chlorinated hydrocarbons, ketones, ethers, and mixtures thereof. In some embodiments, the formulation contains a solvent or a mixture of solvents that makes up about 0.1 to about 90 weight % of the formulation. In some embodiments, a formulation contains between about 0.1 and about 90 weight % solvent, e.g., between about 1 and about 80 weight %, between about 1 and about 60 weight %, between about 1 and about 40 weight %, between about 1 and about 25 weight %, between about 1 and about 10 weight %, between about 10 and about 90 weight %, between about 10 and about 80 weight %, between about 10 and about 60 weight %, between about 10 and about 40 weight %, between about 10 and about 25 weight %, between about 25 and about 90 weight %, between about 25 and about 80 weight %, between about 25 and about 60 weight %, between about 25 and about 40 weight %, between about 40 and about 90 weight %, between about 40 and about 80 weight %, between about 60 and about 90 weight %, between about 0.1 and about 10 weight %, between about 0.1 and about 5 weight %, between about 0.1 and about 3 weight %, between about 0.1 and about 1 weight %, between about 0.5 and about 20 weight %, between about 0.5 and about 10 weight %, between about 0.5 and about 5 weight %, between about 0.5 and about 3 weight %, between about 0.5 and about 1 weight %, between about 1 and about 20 weight %, between about 1 and about 10 weight %, between about 1 and about 5 weight %, between about 1 and about 3 weight %, between about 5 and about 20 weight %, between about 5 and about 10 weight %, or between about 10 or about 20 weight %.

In some embodiments, a formulation may include a surfactant. When included in formulations, surfactants can function as wetting agents, dispersants, emulsifying agents, solubilizing agents and bioenhancing agents. Without limitation, particular surfactants may be anionic surfactants, cationic surfactants, nonionic surfactants, amphoteric surfactants, silicone surfactants (e.g., Silwet L77), and fluorosurfactants. Exemplary anionic surfactants include alkylbenzene sulfonates, olefinic sulfonate salts, alkyl sulfonates and ethoxylates, sulfosuccinates, phosphate esters, taurates, alkylnaphthalene sulfonates and polymers lignosulfonates. Exemplary nonionic surfactants include alkylphenol ethoxylates, aliphatic alcohol ethoxylates, aliphatic alkylamine ethoxylates, amine alkoxylates, sorbitan esters and their ethoxylates, castor oil ethoxylates, ethylene oxide/propylene oxide copolymers and polymeric surfactants, non-ionic copolymers (e.g., commercially available Atlox 4913), anionic copolymers (e.g., Atlox Metasperse 100L, 500L, 550S), and non-ionic block copolymers (commercially available as Atlox 4912). In some embodiments, surfactants can make up between about 0.1 and about 20 weight % of the formulation, e.g., between about 0.1 and about 15 weight %, between about 0.1 and about 10 weight %, between about 0.1 and about 8 weight %, between about 0.1 and about 6 weight %, between about 0.1 and about 4 weight %, between about 1-15 weight %, between about 1 and about 10 weight %, between about 1 and about 8 weight %, between about 1 and about 6 weight %, between about 1 and about 4 weight %, between about 3 and about 20 weight %, between about 3 and about 15 weight %, between about 3 and about 10 weight %, between about 3 and about 8 weight %, between about 3 and about 6 weight %, between about 5 and about 15 weight %, between about 5 and about 10 weight %, between about 5 and about 8 weight %, or between about 10 and about 15 weight %. In some embodiments, a surfactant (e.g., a non-ionic surfactant) may be added to a formulation by the end user, e.g., in a spray tank. Indeed, when a formulation is added to the spray tank it becomes diluted and, in some embodiments, it may be advantageous to add additional surfactant in order to maintain the nanoparticles in dispersed form.

Suitable non-ionic surfactants also include alkyl polyglucosides (APGs). Alkyl polyglucosides which can be used as an adjuvant herein include those corresponding to the formula: R4O(R5O)_{b}(Z3)ₐ wherein R4 is a monovalent organic radical of from 6 to 30 carbon atoms; R5 is a divalent alkylene radical of from 2 to 4 carbon atoms; Z3 is a saccharide residue of 5 or 6 carbon atoms; a is a number ranging from 1 to 6; and, b is a number ranging from 0 to 12. More specifically in some embodiments, R4 is a linear C6 to C12 group, b is 0, Z3 is a glucose residue, and a is 2. Some non-limiting examples of commercially available alkyl polyglucosides include, e.g., APG™, AGNIQUE™, and AGRIMUL″ surfactants from Cognis Corporation (now owned by BASF), and AG™ series surfactants from Akzo Nobel Surface Chemistry, LLC.

In some embodiments, a formulation may include an anti-settling agent or thickener that can help provide stability to a liquid formulation or modify the rheology of the formulation. Examples of anti-settling agents or thickeners include, but are not limited to, guar gum; locust bean gum; xanthan gum; carrageenan; alginates; methyl cellulose; sodium carboxymethyl cellulose; hydroxyethyl cellulose; modified starches; polysaccharides and other modified polysaccharides; polyvinyl alcohol; glycerol alkyd resins such as Latron B-1956 from Rohm & Haas Co., plant oil based materials (e.g., cocodithalymide) with emulsifiers; polymeric terpenes; microcrystalline cellulose; methacrylates; poly(vinylpyrrolidone), syrups, polyethylene oxide, hydrophobic silica, hydrated silica and fumed or hydrophilic silica (e.g., AEROSIL™ 380). One of the advantages of the disclosed invention is the potential elimination of some organic thickeners from the active compound formulations. In some embodiments, xanthan gum, guar gum, carrageen and other organic thickeners are entirely absent, although inorganic thickeners may still be a part of those active compound formulations. In some embodiments, anti-settling agents or thickeners can make up between about 0.05 and about 10 weight % of the formulation, e.g., about 0.05 to about 5 weight %, about 0.05 to about 3 weight %, about 0.05 to about 1 weight %, about 0.05 to about 0.5 weight %, about 0.05 to about 0.1 weight %, about 0.1 to about 5 weight %, about 0.1 to about 3 weight %, about 0.1 to about 2 weight %, about 0.1 to about 1 weight %, about 0.1 to about 0.5 weight %, about 0.5 to about 5 weight %, about 0.5 to about 3 weight %, about 0.5 to about 1 weight %, about 1 to about 10 weight %, about 1 to about 5 weight %, or about 1 to about 3 weight %. In some embodiments, it is explicitly contemplated that a formulation of the present disclosure does not include a compound whose primary function is to act as an anti-settling or thickener. In some embodiments, compounds included in a formulation may have some anti-settling or thickening functionality, in addition to other, primary functionality, so anti-settling or thickening functionality is not a necessary condition for exclusion, however, formulation agents used primarily or exclusively as anti-settling agents or thickeners may be expressly omitted from the formulations.

In some embodiments, a formulation may include one or more preservatives that prevent microbial or fungal degradation of the product during storage. Examples of preservatives include but are not limited to, tocopherol, ascorbyl palmitate, propyl gallate, butylated hydroxyanisole (BHA), butylated hydroxytoluene (BHT), propionic acid and its sodium salt; sorbic acid and its sodium or potassium salts; benzoic acid and its sodium salt; p-hydroxy benzoic acid sodium salt; methyl p-hydroxy benzoate; 1,2-benzisothiazalin-3-one, and combinations thereof. In some embodiments, preservatives can make up about 0.01 to about 0.2 weight % of the formulation, e.g., between about 0.01 and about 0.1 weight %, between about 0.01 and about 0.05 weight %, between about 0.01 and about 0.02 weight %, between about 0.02 and about 0.2 weight %, between about 0.02 and about 0.1 weight %, between about 0.02 and about 0.05 weight %, between about 0.05 and about 0.2 weight %, between about 0.05 and about 0.1 weight %, or between about 0.1 and about 0.2 weight %.

In some embodiments, a formulation may include anti-freezing agents, anti-foaming agents, and/or anti-caking agents that help stabilize the formulation against freezing during storage, foaming during use, or caking during storage. Examples of anti-freezing agents include, but are not limited to, ethylene glycol, propylene glycol, and urea. In certain embodiment a formulation may include between about 0.5 and about 10 weight % anti-freezing agents, e.g., between about 0.5 and about 5 weight %, between about 0.5 and about 3 weight %, between about 0.5 and about 2 weight %, between about 0.5 and about 1 weight %, between about 1 and about 10 weight %, between about 1 and about 5 weight %, between about 1 and about 3 weight %, between about 1 and about 2 weight %, between about 2 and about 10 weight %, between about 3 and about 10 weight %, or between about 5 and about 10 weight %.

Examples of anti-foaming agents include, but are not limited to, silicone based anti-foaming agents (e.g., aqueous emulsions of dimethyl polysiloxane, FG-10 from DOW-CORNING®, Trans 10A from Trans-Chemo Inc.), and non-silicone based anti-foaming agents such as octanol, nonanol, and silica. In some embodiments a formulation may include between about 0.05 and about 5 weight % of anti-foaming agents, e.g., between about 0.05 and about 0.5 weight %, between about 0.05 and about 1 weight %, between about 0.05 and about 0.2 weight %, between about 0.1 and about 0.2 weight %, between about 0.1 and about 0.5 weight %, between about 0.1 and about 1 weight %, or between about 0.2 and about 1 weight %.

Examples of anti-caking agents include sodium or ammonium phosphates, sodium carbonate or bicarbonate, sodium acetate, sodium metasilicate, magnesium or zinc sulfates, magnesium hydroxide (all optionally as hydrates), sodium alkylsulfosuccinates, silicious compounds, magnesium compounds, C10-C22 fatty acid polyvalent metal salt compounds, and the like. Illustrative of anti-caking ingredients are attapulgite clay, kieselguhr, silica aerogel, silica xerogel, perlite, talc, vermiculite, sodium aluminosilicate, aluminosilicate clays (e.g., Montmorillonite, Attapulgite, etc.) zirconium oxychloride, starch, sodium or potassium phthalate, calcium silicate, calcium phosphate, calcium nitride, aluminum nitride, copper oxide, magnesium aluminum silicate, magnesium carbonate, magnesium silicate, magnesium nitride, magnesium phosphate, magnesium oxide, magnesium nitrate, magnesium sulfate, magnesium chloride, and the magnesium and aluminum salts of C10-C22 fatty acids such as palmitic acid, stearic acid and oleic acid. Anti-caking agents also include refined kaolin clay, amorphous precipitated silica dioxide, such as Hi Sil 233 available from PPG Industries, refined clay, such as Hubersil available from Huber Chemical Company, or fumed or hydrophilic silica (e.g., AEROSIL™ 380). In some embodiments, a formulation may include between about 0.05 and about 10 weight % anti-caking agents, between about 0.05 to 5 weight %, between about 0.05 and about 3 weight %, between about 0.05 and about 2 weight %, between about 0.05 and about 1 weight %, between about 0.05 and about 0.5 weight %, between about 0.05 and about 0.1 weight %, between about 0.1 and about 5 weight %, between about 0.1 and about 3 weight %, between about 0.1 and about 2 weight %, between about 0.1 and about 1 weight %, between about 0.1 and about 0.5 weight %, between about 0.5 and about 5 weight %, between about 0.5 and about 3 weight %, between about 0.5 and about 2 weight %, between about 0.5 and about 1 weight %, between about 1 to 3 weight %, between about 1 to 10 weight %, or between about 1 and about 5 weight %.

In some embodiments, a formulation may include a UV-blocking compound that can help protect the active ingredient from degradation due to UV irradiation. Examples of UV-blocking compounds include ingredients commonly found in sunscreens such as benzophenones, benzotriazoles, homosalates, alkyl cinnamates, salicylates such as octyl salicylate, dibenzoylmethanes, anthranilates, methylbenzylidenes, octyl triazones, 2-phenylbenzimidazole-5-sulfonic acid, octocrylene, triazines, cinnamates, cyanoacrylates, dicyano ethylenes, etocrilene, drometrizole trisiloxane, bisethylhexyloxyphenol methoxyphenol triazine, drometrizole, dioctyl butamido triazone, terephthalylidene dicamphor sulfonic acid and para-aminobenzoates as well as ester derivatives thereof, UV-absorbing metal oxides such as titanium dioxide, zinc oxide, and cerium oxide, and nickel organic compounds such as nickel bis (octylphenol) sulfide, etc. Additional examples of each of these classes of UV-blockers may be found in Kirk-Othmer, Encyclopedia of Chemical Technology. In some embodiments, a formulation may include between about 0.01 and about 2 weight % UV-blockers, e.g., between about 0.01 and about 1 weight %, between about 0.01 and about 0.5 weight %, between about 0.01 and about 0.2 weight %, between about 0.01 and about 0.1 weight %, between about 0.01 and about 0.05 weight %, between about 0.05 weight % and about 1 weight %, between about 0.05 and about 0.5 weight %, between about 0.05 and about 0.2 weight %, between about 0.05 and about 0.1 weight %, between about 0.1 and about 1 weight %, between about 0.1 and about 0.5 weight %, between about 0.1 and about 0.2 weight %, between about 0.2 and about 1 weight %, between about 0.2 and about 0.5 weight %, or between about 0.5 and about 1 weight %. In some embodiments, it is explicitly contemplated that a formulation of the present disclosure does not include a compound whose primary function is to act as a UV-blocker. In some embodiments, compounds included in a formulation may have some UV-blocking functionality, in addition to other, primary functionality, so UV-blocking is not a necessary condition for exclusion, however, formulation agents used primarily or exclusively as UV-blockers may be expressly omitted from the formulations.

In some embodiments, a formulation may include a disintegrant that can help a solid formulation break apart when added to water. Examples of suitable disintegrants include cross-linked polyvinyl pyrrolidone, modified cellulose gum, pregelatinized starch, cornstarch, modified corn starch (e.g., Starch 1500) and sodium carboxymethyl starch (e.g., Explotab or Primojel), microcrystalline cellulose, sodium starch glycolate, sodium carboxymethyl cellulose, carmellose, carmellose calcium, carmellose sodium, croscarmellose sodium, carmellose calcium, carboxymethylstarch sodium, low-substituted hydroxypropyl cellulose, hydroxypropyl methylcellulose, hydroxypropyl cellulose, soy polysaccharides (e.g., EMCOSOY), alkylcelullose, hydroxyalkylcellulose, alginates (e.g., Satialgine), dextrans and poly(alkylene oxide) and an effervescent couple (e.g., citric or ascorbic acid plus bicarbonate), lactose, anhydrous dibasic calcium phosphate, dibasic calcium phosphate, magnesium aluminometasilicate, synthesized hydrotalcite, silicic anhydride and synthesized aluminum silicate. In some embodiments, disintegrants can make up between about 1 and about 20 weight % of the formulation, e.g., between about 1 and about 15 weight %, between about 1 and about 10 weight %, between about 1 and about 8 weight %, between about 1 and about 6 weight %, between about 1 and about 4 weight %, between about 3 and about 20 weight %, between about 3 and about 15 weight %, between about 3 and about 10 weight %, between about 3 and about 8 weight %, between about 3 and about 6 weight %, between about 5 and about 15 weight %, between about 5 and about 10 weight %, between about 5 and about 8 weight %, or between about 10 and about 15 weight %.

The active compound formulations of the invention can be applied directly to the soil to control soil-borne or soil-welling pests. Methods of application to the soil can be any suitable method which ensures that the active compound formulations penetrate the soil and are near the plants, plant propagation material, or expected loci of plants and plant propagation materials. Application methods include, but are not limited to in furrow application, T-band (or other band) application, soil injection, soil drench, drip irrigation, application through sprinklers or central pivot, and incorporation to the soil (e.g., broadcast).

The active compound formulations of the invention can be diluted so that any one of the active compound concentrations is less than about 1%, prior to application. In some embodiments, the concentration of any one active compound is less than about 0.5%, less than about 0.25%, less than about 1.5%, less than about 2% or less than about 2.5%. These dilutions, the tank-mix of the active compound formulations, is then applied to the plant to be treated, its locus, or the soil to which a plant or plant propagation material will be planted. In preparing tank-mix dilutions, the active compound formulations can be mixed with water, liquid fertilizer or any other diluent suitable for agricultural applications. Additionally, surfactants (e.g., non-ionic, anionic) can also be added to tank-mixes, as well as micronutrient additives, or any other suitable additive known in the art.

The term “plant propagation material” is understood to denote all the generative parts of the plant, such as seeds, which can be used for multiplication of the latter and vegetative plant material such as cutting and tubers. Plant propagation material also includes roots, fruits, tubers, bulbs, rhizomes and parts of plants. Germinated plants and young plants, which are to be transplanted after germination or after emergence from the soil may also be included in this term. These young plants may be protected before transplantation by a total or partial treatment with the active compound formulations of the invention by any application method (e.g., immersion, drench, drip irrigation).

### EXAMPLES

### Example 1: Formulation of Acetamiprid

Three suspension concentrate formulations of Acetamiprid were prepared, two including a polymeric crystallization inhibitor (two different polymers), the others omitting the polymer crystallization inhibitor. Each formulation targeted 35 weight percent active compound (acetamiprid) and 50 grams of final formulation, except batch number 11, which had a target of 150 grams. Each was prepared according to the recipe below in Table 1.

TABLE 1

| | Batch No.: | | |
|---|---|---|---|
| | 63 | 74 | A11 |
| Ingredient | weight (g) | weight (g) | weight (g) |
| Acetamiprid (99.1% technical) | 17.66 | 17.66 | 52.8 |
| poly(methacrylic acid-co | 0 | 16.67 | 0 |
| styrene) 70:30 polymer | | | |
| 14.7% solution) | | | |
| Poly(AMPS-co-ethyl acrylate) 50:50 | 3.25 | 0 | 0 |
| Morwet D425 (Akzo Nobel) | 1.75 | 1.75 | 4.5033 |
| Morwet EFW (Akzo Nobel) | .25 | 0.25 | 2.254 |
| Van Gel B granules (Cary Co.) | 0 | 0 | 0.7506 |
| Propylene glycol (generic) | 2.23 | 2.3 | 7.4295 |
| Trans 10-A (10% Solution - | 0.3 | 0.3 | 0.9003 |
| TransChemco | | | |
| Proxel BD-20 (19.3 wt % | 0.10 | 0.10 | 0.3093 |
| solution - Lonza) | | | |
| RO water | 24.44 | 10.97 | 80.878 |

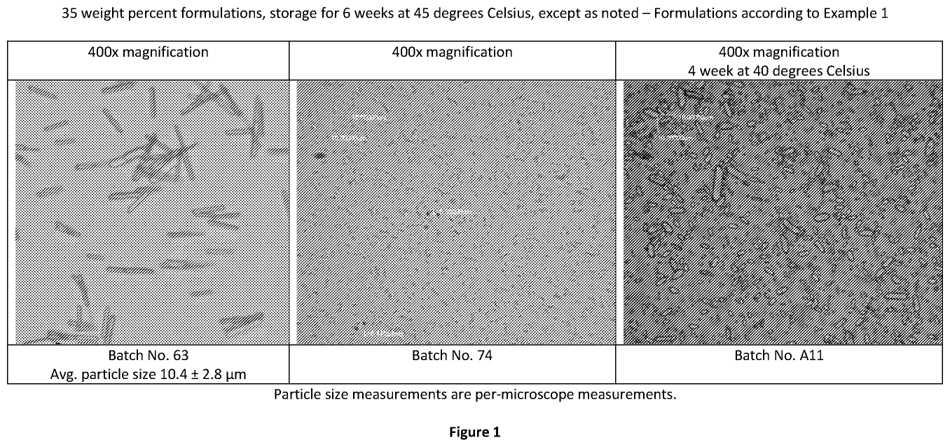

After preparation, each formulation was stored at 45 degrees Celsius. Samples were withdrawn after 3 weeks and 6 weeks of storage and analyzed under a microscope for crystal growth. See FIG. 1 showing photos under magnification of samples withdrawn after 4 or 6 weeks of storage at 40 or 45 degrees Celsius. Particle size measurements are per-microscope measurements.

### Example 2: Acetamiprid at High Temperature Storage

An improved suspension concentrate formulation of acetamiprid was prepared based Batch No. 74 from Example 1. The formulation targeted 35 weight percent active compound (acetamiprid) and 150 grams of final formulation. The formulation was prepared according to the recipe in Table 2 below.

TABLE 2

| | Batch No.: |
|---|---|
| | 46 |
| Ingredient | weight (g) |
| Acetamiprid (99.6% technical) | 52.7108 |
| poly(methacrylic acid-co styrene) 70:30 polymer | |
| 22.26% solution) | 20.2156 |
| Morwet D425 (Akzo Nobel) | 2.2500 |
| Morwet EFW (Akzo Nobel) | 1.5000 |
| Van Gel B granules (Cary Co.) | 1.5000 |
| Propylene glycol (generic) | 7.2300 |
| Trans 10-A (10% Solution - TransChemco) | 0.9000 |
| Proxel BD-20 (19.3 wt % solution - Lonza) | 0.3109 |
| RO water | 63.3826 |

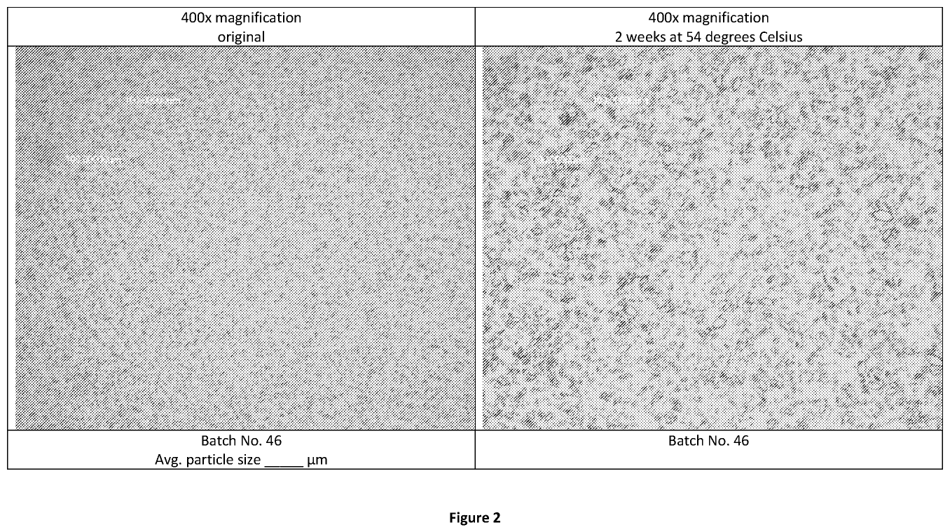

After preparation, the formulation was stored at 54 degrees Celsius, withdrawn after 2 weeks of storage and analyzed under a microscope for crystal growth. See FIG. 2 showing photos under magnification of samples withdrawn after 2 weeks of storage at 54 degrees Celsius. Particle size measurements are per-microscope measurements. As can be seen from a comparison of batch nos. 63, A11, and 74 and 46 in FIGS. 1 and 2 (both under 400× magnification), the addition of the crystallization inhibiting polymer (poly(methacrylic acid-co styrene) 70:30 polymer) to batches 74 and 46 reduced the size of the size of crystals that formed during elevated temperature storage at 40, 45, or 54 degrees Celsius.

### Example 3: Formulation of Propanil Herbicide

Two formulations of propanil were prepared, one including a polymeric crystallization inhibitor, the other omitting the polymer crystallization inhibitor.

TABLE 3

| | Batch No.: | |
|---|---|---|
| | 58 | 56 |
| Ingredient | weight (g) | weight (g) |
| Propanil (97.9%) | 21.1 | 21.1 |
| Poly(methacrylic acid-co styrene) | 8.7 | 0 |
| 70:30 polymer | | |
| (23% solution) | | |
| Morwet EFW | 0.5 | 0.5 |
| Morwet D425 | 0.75 | 0.75 |
| Propylene Glycol | 2.25 | 2.25 |
| Surfynol 104 PG50 | 0.15 | 0.15 |
| Trans 10-A | 0.5 | 0.5 |
| Proxel BD-20 | 0.1 | 0.1 |
| Water | 15.9 | 24.6 |

The formulations were prepared separately but according to the same general process. All of the solid contents (Propanil active, Morwet EFW, & Morwet D425) were placed into the tank under teeth grinder, and mixed. Poly(methacrylic acid-co-styrene) polymer solution (23% solution) (where applicable), a portion of the water, and the Trans-10A. Then the tank was then transferred to a homogenizer and homogenized at 4500 RPM for 60 min. No foam was generated in this stage. The mixture was removed from the homogenizer and Proxel BD-20, propylene glycol, and remaining water were added while the mixture was under a U-shaped stirrer. The resulting mixture was milled the next day for 150 minutes, with Surfonyl added during milling as needed. Once milling was finished the mixture was passed through a 60 mesh screen

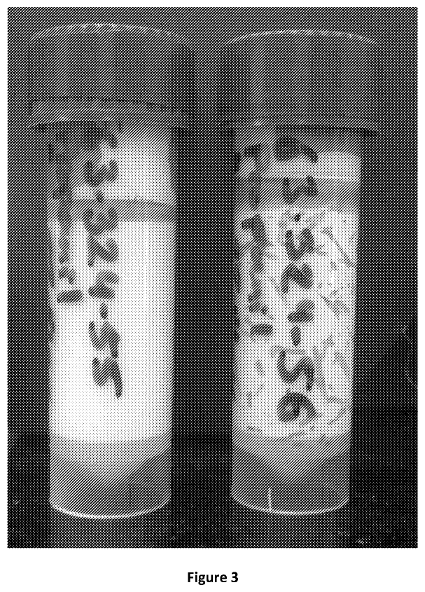

Samples of the two formulations were stored in 10 ml vials for 1 week at 54 degrees Celsius. These storage conditions are designed to mimic storage for 1 year at room temperature. After the storage period, the vials were removed from the oven and observed for crystal formation. Photographic results are shown in FIG. 3.

### Example 4: Metalaxyl

A metalaxyl formulation was prepared (1500 g target weight total), with polymeric nanoparticle solution, according to the table and process detailed below. After preparation of this formulation, two samples were withdrawn, to one sample was added crystallization inhibiting polymer, and to the other sample an equivalent amount of water was added. The two modified samples were analyzed and observed for crystal growth.

TABLE 4

| | Batch No.: |
|---|---|
| | 31 |
| Ingredient | weight (g) |
| Metalaxyl | 1531.5 |
| poly(methacrylic acid-co-ethyl acrylate) 90:10 | 1043 |
| nanoparticle solution (12% solution) | |
| Morwet D425 (Akzo Nobel) | 50 |
| Stepwet DF-90 | 5.01 |
| Agnique 9116 | 50 |
| Aerodisp W7512S (12% in water) | 1145.9 |
| Propylene glycol | 255.5 |
| Trans 10-A | 50 |
| Surfonyl 104 PG50 | 15 |
| Proxel BD-20 | 10.3 |
| RO water | 637.66 |

All of the solid contents (Metalaxyl, & Morwet D425) except Stepwet, were placed into the tank under teeth grinder, along with poly(methacrylic acid-co-ethyl acrylate) nanoparticle solution (12% solution), a portion of the water, 25 grams of Trans-10A, and 377.5 g Aerodisp mixture. Then the tank was then transferred to a homogenizer and homogenized at 4600 RPM for 60 min. No foam was generated in this stage. The mixture was removed from the homogenizer and Stepwet, Agnique, Proxel BD-20, propylene glycol, Trans 10-A, and remaining water were added while the mixture was under a U-shaped stirrer. The resulting mixture was milled the next day for 165 minutes, with Surfonyl added during milling as needed. Size measurements were conducted under a microscope. Once milling was finished the mixture was passed through a 60 mesh screen

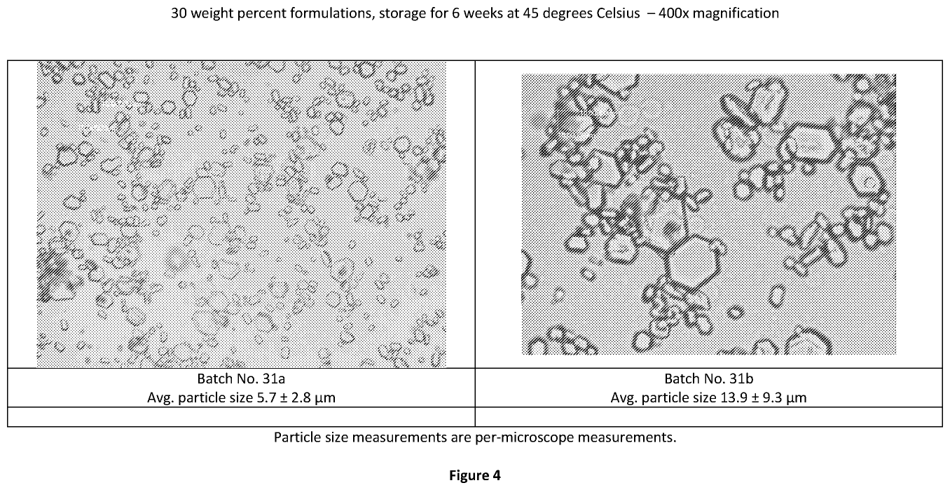

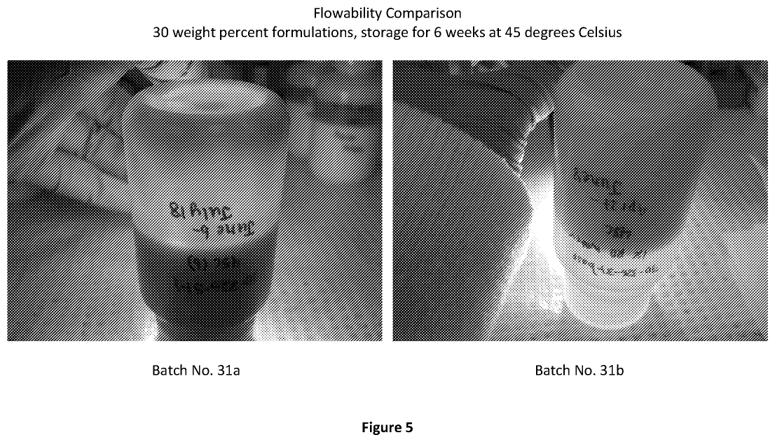

The formulation was divided in two samples. To the first division, 1% of the total weight of the formulation of poly(methacrylic acid-co styrene) 70:30 polymer was added, becoming batch 31a. To the other half of the formulation, 1% of the total weight of the formulation of additional RO water was added, becoming batch 31b. Samples were withdrawn and stored at 45 degrees Celsius for 6 weeks, then examined under microscopy (see FIG. 4 and analyzed for flowability (see FIG. 5). The sample from batch 31a had smaller average particles size, demonstrated apparent smaller crystals than the sample from batch 31b. Additionally, the sample from batch 31b was not flowable after storage, while the sample from batch 31a was. Particle size measurements are per-microscope measurements.

### Example 5: Metalaxyl

A metalaxyl formulation was prepared (5000 g target weight total), with polymeric nanoparticle solution and crystallization inhibiting polymer (poly(methacrylic acid-co styrene)), according to the table and process detailed below. Both polymeric components are considered to inhibit crystal growth of the active ingredient.

TABLE 5

| | Batch No.: |
|---|---|
| | 120 |
| Ingredient | weight (g) |
| Metalaxyl | 1597 |
| poly(methacrylic acid-co-ethyl acrylate) | 415.5 |
| 90:10 nanoparticle solution | |
| (12% solution) | |
| Poly(methacrylic acid-co styrene) 70:30 | 369 |
| polymer (23% solution) | |
| Agnique 9116 | 51.5 |
| Morwet D425 (Akzo Nobel) | 50.5 |
| Stepwet DF-90 | 5 |
| Van Gel B granules (Cary Co.) | 137 |
| Propylene glycol | 247.5 |
| Surfonyl 104 PG50 | 15 |
| Proxel BD-20 | 10.5 |
| Trans 10-A | 50.5 |
| RO water | 2054 |

Morwet was dissolved in poly(methacrylic acid-co-ethyl acrylate) 90:10 nanoparticle solution, with half of the Poly(methacrylic acid-co styrene) 70:30 polymer solution and propylene glycol under teeth grinder. The metalaxyl was added, followed by a portion of the water and it was stirred for 30 minutes. Trans-10A was then added to defoam with a small portion of the Surfynol. Van Gel B granules were added and the resulting mixture was stirred for another 30 mins. The sample containing flask was then covered with parafilm and stored overnight at room temperature. The next day there was separation with a portion of the mixture settling on the bottom of the flask. It was redispersed under teeth grinder with an addition of 21 g of Trans-10A and some water. The sample was then homogenized at 4500 RPM for 30 min. There was no foam generated in this stage. Afterwards, the remaining trans-10A was added with some additional Surfynol. Then Stepwet solution, Agnique and Proxel BD-20 were added. The mixture was milled for 50 min and the particle size was measured at about 1.4 um. Under the U-shape stirrer, the remaining amount of Surfynol was added, and stirred for 20 min. The sample went through the 100 mesh strainer with ease.

CIPAC Syneresis Testing was performed after various storage conditions. Specifically, after storage for 3 weeks and 6 weeks at 45 degrees Celsius, and after 2 months of room temperature storage. A summary of the results is presented in Table 6 below.

TABLE 6

| | | | Syneresis | |
|---|---|---|---|---|
| | Sample | Syneresis | as a | |
| | Height | Height | Percentage | |
| | (mm) | (mm) | of Sample | Observations |
| 3 wk @ | 70 | 12 | 17.1% | Light tan, flows |
| 45 C. | | | | well and no |
| | | | | sediment. Next day, |
| | | | | poured smooth. |
| 6 wk @ | 71 | 10 | 14.1% | Light tan, flows |
| 45 C. | | | | well and no |
| | | | | sediment. Next day, |
| | | | | poured smooth. |
| RT | 74 | 5 | 6.8% | Flows well |
| Stability | | | | |
| (2 mo.) | | | | |

All three storage samples were also passed through sieve tests (100 and 50 mesh). The original formulation passed through both meshes with ease. The sample stored for 3 weeks at 45 degrees Celsius passed through both meshes, but left 2-3 small crystals on the mesh. The sample stored for 6 weeks at 45 degrees Celsius left several large flakes on the mesh.

Viscosity (Brookfield) Testing was also performed at various speed. Results are presented in Table 7 below.

TABLE 7

| Speed | Torque | Temp | Viscosity |
|---|---|---|---|
| [RPM] | [%] | [C.] | [cP] |
| 4 | 2.0% | 26.0 | 150 |
| 12 | 2.6% | | 65 |
| 20 | 3.6% | | 54 |

Particle Size Measurements of the original, unstored formulation were performed and the results in Table 8 below:

TABLE 8

| Particle Size | Mean (Ave) | D(v, 0.1) | D(v, 0.5) | D(v, 0.9) |
|---|---|---|---|---|
| AN018 rev07 | [um] | [um] | [um] | p[um] |
| Original | 1.746 | 0.302 | 1.321 | 3.880 |

### Example 6: Metalaxyl

A metalaxyl formulation was prepared (50 g target weight total), with polymeric nanoparticle solution and crystallization inhibiting polymer (poly(methacrylic acid-co styrene)), according to the table and process detailed below. Both polymeric components are considered to inhibit crystal growth of the active ingredient. Reduction or elimination of traditional surfactant compounds (e.g., Stepwet, Morwet) is utilized to further test crystal inhibiting effect of polymer, polymer nanoparticle components.

TABLE 9

| | Batch No.: |
|---|---|
| | 77 |
| Ingredient | weight (g) |
| Metalaxyl | 15.9694 |
| Poly(methacrylic acid-co styrene) 70:30 | 7.177 |
| polymer (23% solution) | |
| poly(methacrylic acid-co-ethyl | 12.5 |
| acrylate) 90:10 nanoparticle | |
| solution (12% solution) | |
| Van Gel B granules (Cary Co.) | 0.5 |
| Propylene glycol | 0.1036 |
| Soprophor BSU | 10.35 |
| Trans 10-A | 15.9694 |
| Proxel BD-20 | 7.177 |
| RO water | 12.5 |

The sample was stored for 3 weeks at 45 degrees Celsius, withdrawn and tested for stability. The post-storage sample was flowable and passed through a 50 mesh sieve with ease. No aggregates were retained on the screen. The sample displayed some syneresis and separate, but the layers were reincorporated with ease after about 10 inversions. The viscosity (Brookfield at 12 rpm S31) was measured at 235 cP. The average particle size (by microscope) was measured as 4.2 μm and the d.90 was 15.7 μm.

### Example 7: Qualitative Testing with Metalaxyl

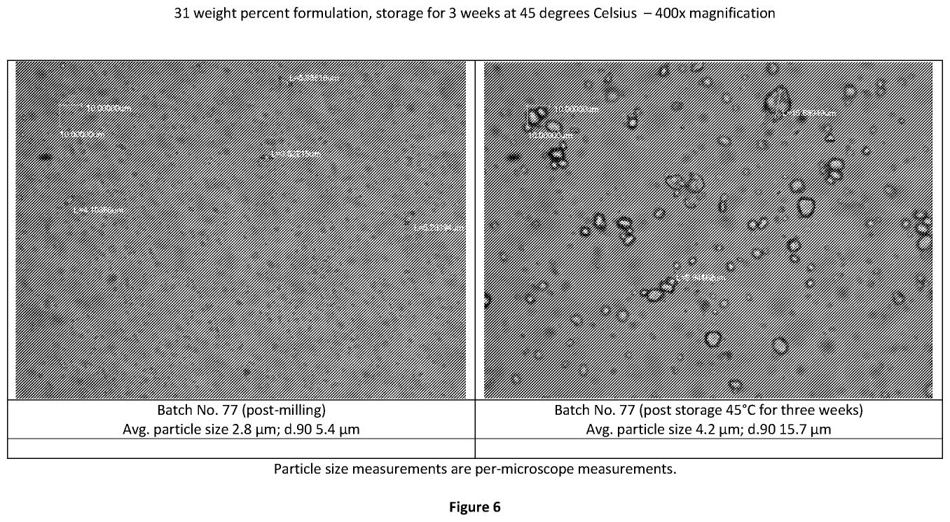

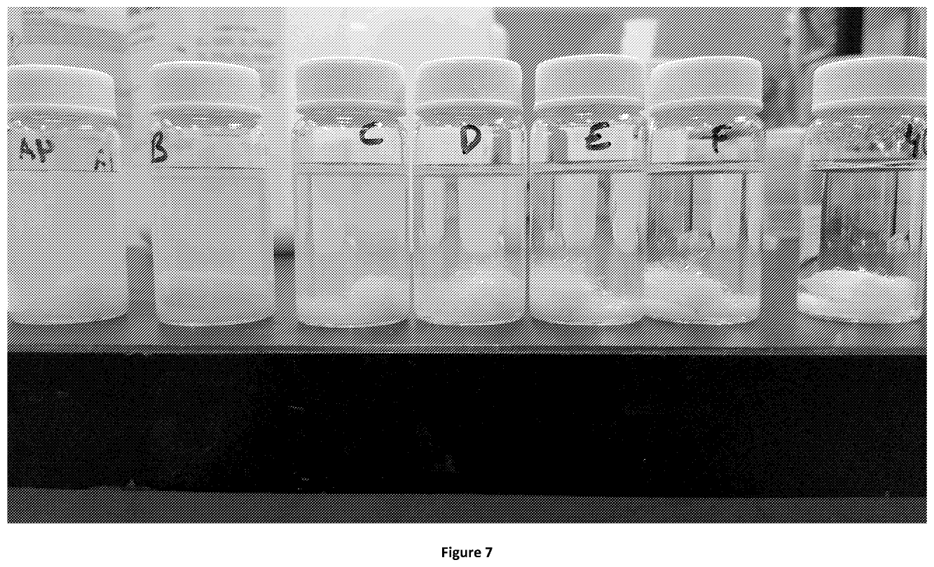

Seven mixtures of metalaxyl, in RO water, with varying amounts of crystal inhibiting polymer (Poly(methacrylic acid-co styrene) 70:30 polymer) were prepared, according to Table 10 below. Each sample was placed in a 54 degree Celsius oven, stored overnight, removed, and left at room temperature for one day before visual analysis, see FIG. 7. A review of the photograph in FIG. 6 of the various samples demonstrates varying degrees of crystallization inverse to the weight percentage of crystal inhibiting polymer, i.e., the samples with a higher weight percentage of polymer demonstrated reduced crystallization, whereas the samples without any polymer, or lower concentrations demonstrated the most amount of crystal formation.

TABLE 10

| | | RO | Polymer | | | |
|---|---|---|---|---|---|---|
| | Al | H2O | (g) | Polymer | Polymer | Polymer:Al |
| Vial | (g) | (g) | (23 wt %) | wt % | wt% | Ratio |
| 4A | 0.8 | 8.48 | 6.52 | 9.49% | 9.49% | 1.87 |
| 4B | 0.8 | 11.74 | 3.26 | 4.7% | 4.75% | 0.94 |
| 4C | 0.8 | 13.70 | 1.30 | 1.9% | 1.89% | 0.37 |
| 4D | 0.8 | 14.35 | 0.65 | 0.9% | 0.95% | 0.19 |
| 4E | 0.8 | 14.67 | 0.33 | 0.5% | 0.48% | 0.09 |
| 4F | 0.8 | 14.80 | 0.07 | 0.1% | 0.10% | 0.02 |
| 4G | 0.8 | 15 | 0.00 | 0.0% | 0.00% | 0.00 |

1. A method of inhibiting crystallization of an active compound comprising preparing a formulation of the active compound by milling the active compound with a polymer, a dispersant and/or a wetting agent, and water,
wherein the active compound is selected from the group consisting of fungicides, insecticides, nematicides, herbicides, safeners, growth regulators, and combinations thereof.

2. The method of any one of the preceding claims, wherein the active compound has a water solubility of at least about 0.5 ppm at a temperature of about 25 degrees Celsius and a pH of about 7.

3. The method of any one of the preceding claims, wherein the active compound has a water solubility of at least about 100 ppm at a temperature of about 25 degrees Celsius and a pH of about 7.

4. The method of any one of the preceding claims, wherein the active compound has a water solubility of at least about 500 ppm at a temperature of about 25 degrees Celsius and a pH of about 7.

5. The method of any one of the preceding claims, wherein the active compound has a water solubility of at least about 1000 ppm at a temperature of about 25 degrees Celsius and a pH of about 7.

6. The method of any one of the preceding claims, wherein the active compound has a water solubility of less than about 10000 ppm at a temperature of about 25 degrees Celsius and a pH of about 7.

7. The method of any one of the preceding claims, wherein the polymer is a polyelectrolyte.

8. The method of claim 7, wherein the polymer comprises hydrophobic and hydrophilic monomers.

9. The method of claim 7, wherein the polymer consists essentially of hydrophobic and hydrophilic monomers.

10. The method of any one of the preceding claims, wherein the polymer comprises styrene and methacrylic acid monomers.

11. The method of claim 10, wherein the polymer has a weight ratio of styrene monomers to methacrylic acid monomers of between about 1:1: and about 1:9.

12. The method of claim 10, wherein the polymer has a weight ratio of styrene monomers to methacrylic acid monomers of between about 2:3 and about 1:4.

13. The method of claim 10, wherein the polymer has a weight ratio of styrene monomers to methacrylic acid monomers of about 3:7.

14. The method of any one of claims 1-9, wherein the polymer comprises AMPS monomers and ethyl acrylate monomers.

15. The method of claim 14, wherein the polymer has a weight ratio of AMPS monomers to ethyl acrylate monomers of between about 1:4 and about 4:1.

16. The method of any one of the preceding claims, wherein the active compound is selected from the group consisting of acetamiprid, propanil, metalaxyl, and combinations thereof.

17. The method of any one of claims 1-16 wherein the active compound is selected from neonicotinoid insecticides, phenylamide fungicides, anilide herbicides, amide herbicides, herbicide safeners, and combinations thereof.

18. A formulation comprising
an active compound;
a polymer;
a dispersant and/or a wetting agent; and
water,
wherein the active compound is selected from the group consisting of fungicides, insecticides, nematicides, herbicides, safeners growth regulators, and combinations thereof.

19. The formulation of claim 18 wherein the active compound has a water solubility of at least about 0.5 ppm at a temperature of about 25 degrees Celsius and a pH of about 7.

20. The formulation of any one of claims 18-19, wherein the active compound has a water solubility of at least about 100 ppm at a temperature of about 25 degrees Celsius and a pH of about 7.

21. The formulation of any one of claims 18-20, wherein the active compound has a water solubility of at least about 500 ppm at a temperature of about 25 degrees Celsius and a pH of about 7.

22. The formulation of any one of claims 18-21, wherein the active compound has a water solubility of at least about 1000 ppm at a temperature of about 25 degrees Celsius and a pH of about 7.

23. The formulation of any one of claims 18-22, wherein the active compound has a water solubility of less than about 10000 ppm at a temperature of about 25 degrees Celsius and a pH of about 7.

24. The formulation of any one of claims 18-23, wherein the polymer comprises hydrophobic and hydrophilic monomers.

25. The formulation of any one of claims 18-24, wherein the polymer consists essentially of hydrophobic and hydrophilic monomers.

26. The formulation of any one of claims 18-25, wherein the polymer comprises styrene and methacrylic acid monomers.

27. The formulation of claim 26, wherein the polymer has a weight ratio of styrene monomers to methacrylic acid monomers of between about 1:1: and about 1:9.

28. The formulation of claim 27 wherein the polymer has a weight ratio of styrene monomers to methacrylic acid monomers of between about 2:3 and about 1:4.

29. The formulation of claim 28 wherein the polymer has a weight ratio of styrene monomers to methacrylic acid monomers of about 3:7.

30. The formulation of any one of claims 18-25, wherein the polymer comprises AMPS monomers and ethyl acrylate monomers.

31. The formulation of claim 30, wherein the polymer has a weight ratio of AMPS monomers to ethyl acrylate monomers of between about 1:4 and about 4:1.
